(19) United States
(12) Patent Application Publication
(10) Pub. No.: US 2002/0103898 A1
(43) Pub. Date: Aug. 1, 2002

(54) System and method for using session initiation protocol (SIP) to communicate with networked appliances

(76) Inventors: Stanley L. Moyer, Mendham, NJ (US); David J. Marples, Mansfield (GB); Simon Tsang, Jersey City, NJ (US); Christain Huitema, Clyde Hill, WA (US)

Correspondence Address: Joseph Giordano, Esq., Telcordia Technologies, Inc., 445 South Street, Room 1G-112R, Morristown, NJ, 07960, US

(21) Appl. No.: 09/774,999

(22) Filed: Jan. 31, 2001

(51) Int. Cl. G06F 15/173; G06F 15/16

(52) U.S. Cl. 709/224; 709/230; 709/246

(57) ABSTRACT

Session Initiated Protocol (SIP) is used to communicate with Network-capable appliances by leveraging SIP capabilities to directly communicate with appliances, even when they are behind firewalls, Network Address Translators or other entities that prevent direct end-to-end communication. A remote user agent client (UAC) sends a message over the Internet via proxy servers to a user agent server at the location of the appliances, e.g., the client's home. This communications channel allows the client to control the appliances and to determine their status. In order to enable this operation, conventional SIP messages are extended to a DO message that includes a universal resource locator (URL) without location information otherwise specified in the SIP message and a generalized payload body with control and/or query instructions specific to networked appliances. When the command message is a SIP INVITE type, it includes a description of the appliance.

### CROSS-REFERENCE TO RELATED APPLICATIONS

This application is related to commonly owned U.S. patent application Ser. No. ______ (Attorney Docket APP 1300) filed concurrently herewith and entitled “System and Method For Out-Sourcing The Functionality of Session Initiation Protocol (SIP) User Agents to Proxies.” This application is also related to commonly owned U.S. patent application Ser. No. ______ (Attorney Docket APP 1257) filed concurrently herewith and entitled “Smart Appliance Network System and Communication Protocol.”

### BACKGROUND OF THE INVENTION

This invention relates to the communication of control signals and status signals over a network to effect operation of Networked Appliances and, more particularly, to the use of Session Initiation Protocol to improved communications with a plurality of Networked Appliances.

The remote control of appliances networked together is a new and growing area of interest. In a typical embodiment, a home can have all or many of its appliances connected to a network. With such a system, the homeowner can access the network and turn on the lights in the driveway, start the coffee maker, and raise or lower the temperature in the home, even before leaving the office. Also, the refrigerator can keep an inventory of your groceries and re-order when necessary. A clock can co-ordinate the user's agenda or perhaps turn on an appliance. To achieve this functionality, it is clear that these appliances need to communicate with each other so that, for example, the alarm clock can turn on the bedroom lamp.

Networked Appliances (NAs) are dedicated consumer devices containing at least one networked processor. As an alternative, conventional appliances can be connected to an appliance controller which accepts remote messages and controls the appliance in the desired way. As a result, a substantial amount of computing power is need in each controller.

In Networked Appliance systems there are the following considerations that need to be accommodated when considering communication outside of the home, notably:

Security—In-home communication exploits a level of physical security that is lost when arbitrary access from outside of it is permitted.

Authentication—The entity trying to enter into the home needs to be unambiguously identified prior to permitting access.

Reliability—Because of the wide-area nature of extra-home access, there are more points of failure. The home should continue to operate independently of external systems when communication with them is lost.

Scaling—there are very many homes.

Protocol Independence—Although within a single home it is acceptable that many different protocols are used for inter-device communication, a much more protocol-independent approach is required for the wide area, since the exact details of the devices comprising the in-home network may not be known from the outside world.

Naming and Location—Devices within the home need to be unambiguously named and their location identified from outside of it.

Techniques are being developed to begin to allow control of a device in the home from the outside world, most notably by the Open Services Gateway Initiative (OSGi). See OSGi, www.osgi.org. However, this prior system still does not address the general problem of wide area access and security, as well as the other concerns expressed above. These systems do not provide a uniform protocol for communication over the Internet.

The Internet Engineering Task Force (“IETF”) has developed a communications protocol called Session Initiation Protocol (“SIP”) which can accommodate a number of different modes of communication. SIP, according to proposed standard RFC 2543, is a an application-layer control and signaling protocol for creating, modifying and terminating interactive communications sessions between one or more participants. It is a text-based protocol similar to HTTP and SMTP. These sessions may include voice, video, chat, interactive games and virtual reality, e.g., Internet multimedia conferences, Internet telephone calls and multimedia distribution. Members in a session can communicate via multicast or via a mesh of unicast relations, or a combination of these.

SIP invitations (i.e., the SIP method INVITE) are used to create sessions. These invitations can carry session descriptions which allow participants to agree on a set of compatible media types. SIP supports user mobility by proxying and redirecting requests to the user's current location, which the user can register. SIP is not tied to any particular conference control protocol, but instead it is designed to be independent of the lower-layer transport protocol.

The SIP architecture includes user agents, where a user agent is a device running an application program that can act as both a user agent client (“UAC”) and a user agent server (“UAS”). A client is an application program that sends SIP requests. A client may or may not interact directly with a human user.

A server is an application program that accepts requests from a client in order to service those requests and sends back responses to those requests. Thus, a UAS is a server application that contacts the user when a SIP request is received and that returns a response on behalf of the user. The response accepts, rejects or redirects the request.

In addition there are servers which are not User Agents. These can be Proxy, Redirect or Registrar servers. A Proxy server is an intermediary program that acts as both a server and a client for the purpose of making requests on behalf of other clients. Requests are serviced internally by the Proxy server or are passed by it to other servers, possibly after translation. A Proxy server interprets, and, if necessary, rewrites a request message before forwarding it. In an Internet context, the Proxy server receives requests from a UAC, even when directed to a host with a different URL. After processing, it sends these on to the destination URL.

A Redirect server is a server that accepts a SIP request, maps the address into zero or more new addresses and returns these addresses to the client. Unlike a Proxy server, it does not initiate its own SIP request. Unlike a UAS, it does not accept calls.

A Registrar server is a server that accepts REGISTER requests. It keeps a list of the registered addresses it receives for the UAS devices in its area and is typically co-located with a Proxy or Redirect server so it can share its information with them.

In a SIP configuration the UAC sends a request to a UAS via one or more Proxy servers. Typically one UAC may address or be capable of addressing multiple UASs. Further, in a standard SIP architecture, endpoints, i.e., UASs, are always able to communicate directly with each other. Applying this structure to a typical multimedia conference, the control application would act as a UAC to initiate calls or to invite others to conferences and it would act as a UAS to accept invitations. The role of UAC and UAS as well as Proxy and Redirect servers are defined on a request-by-request basis. For example, the user agent initiating a call acts as a UAC when sending the initial NVITE request and as a UAS when receiving a BYE request from the device called. Similarly, the same software can act as a Proxy server for one request and as a Redirect server for the next request. The SIP UAS will typically be embedded in SIP phones, PCs and PDAs. These UAS devices are responsible for authenticating the originator of the message and then determining if that entity is authorized to perform the requested operation (typically by consulting an access control list).

There are certain features of the SIP architecture that suggest that it might be useful for communications with Networked Appliances, but with more general applicability to any networked device in which the location phase and communication (or action) phases are merged into a single activity. In particular, SIP allows mobility, i.e., a recipient device can be moved so long as it is registered again at its new location.

SIP is a transactional service, consisting of sequences of request-response transactions within a common context (identified by the Call-ID). This would also apply to a Networked Appliance connection where a conversation (session) is initiated by a first message and the responses and other messages are to be grouped together. Further, SIP uses MIME for transport of content. Thus, the meaning and purpose of the content depend on the request method and on the content type. SIP uses numerous header fields for identification of the users involved in the communication. This function would be useful in Networked Appliance connections. Further, SIP has authentication tools and security mechanisms that are necessary for Networked Appliance systems that allow remote access.

Importantly, in a Networked Appliance system with access from outside the home, a requesting agent must send an instruction to perform an action on a named object in a message. The message would contain the name of the object upon which the action should be performed as its address, and the action itself as the payload. This message would be routed from agent to agent, resolving the name as it goes along. For example, the command “Switch on the lamp in the master bedroom in Dave's house” would first be routed to the server that knows the location of Dave's house. Then the message would be routed on to the firewall device at Dave's house, where access control and authorization would be performed. If this is successful, the message payload would then be delivered to the device to perform whatever action has been requested.

In SIP this routing by name function is achieved in the INVITE process. In particular, an INVITE is sent first to an agent, or proxy, for the name. The Proxy can rewrite the name and relay the INVITE, getting closer to the eventual destination for the message and delivering the payload (which is conventionally in a Session Description Protocol (SDP)) once it arrives. The Location and Action processes are intertwined in the same procedure. In addition, the SIP security architecture enables verification based on these high level names.

However, there are two essential differences between the capabilities of SIP and the identified requirements for a communication with Networked Appliances. First, SIP location information is in the form of a URL which is on Internet Domain Name Server (DNS) address. However, not all Networked Appliances have an IP address (e.g., an X.10 device behind an appliance controller). Second, the only action that the SIP INVITE message can perform is to set up a session with associated bearers, using SDP (or some other MIME TYPE, e.g., ISUP/QSIG). Thus, it can set up a video conference, but INVITE is not designed to transmit messages that control a device.

Also, prior Networked Appliance systems have not provided security for access from outside the home, events and media streaming. Thus, it would be advantageous if SIP or some other system could be adapted to meet all of the needs for Networked Appliance systems.

### SUMMARY OF THE INVENTION

The present invention is directed to the remote communication of messages over a network and, more particularly, to improved remote control of Networked Appliance using a SIP network. To accomplish this, some aspects of SIP must be modified. In particular, the SIP command message includes a universal resource locator (URL) with the location information deleted. This information is otherwise specified in another part of the SIP message. Further, SIP must be extended to include a new command message called “DO.” This DO type has the “connection established phase” removed and the message payload generalized. Also, the command message payload has a device messaging protocol (DMP) MIME type. When the command message is a SIP INVITE type, it includes a description of the appliance.

In a preferred embodiment the SIP User Agents and Proxies are modified to deal with the new DO type. The typical SIP architecture is then used with a SIP User Agent Client, e.g., a homeowner logging-in from his office, and sending a message to appliances at his home. The message is some form of command or request for status information and is transmitted as part of the new DO message. The signal is passed to an outbound proxy near the user's office, which authenticates it as being from the user by means of the SIP challenge-response mechanism. Reading the headers in the DO message, the outbound proxy passes the message on to other proxies until it reaches a firewall or residential gateway at the user's home. Using SIP capabilities, the request is authenticated at the gateway. Then the message is passed onto a LAN in the user's home where it is passed onto the target appliance. The appliance or a controller connected to it, acknowledges the receipt of the message to the user, performs the requested action, and may return status information to the user under the same Call-Id that set up the message session.

Depending on the arrangement, the User Agent Server (UAS) at the gateway or at the individual appliances must not only authenticate that the message is from the owner, but that the requested action is authorized. For example, the user's child may be authorized to turn on the lights, but not the coffee maker. Thus, authentication and authorization are separate actions that need to be performed. Further, the gateway or UAS must have address mapping capability to locate the specific device on the LAN that is the target of the message. Finally, the UAS may be required to translate the message from the standard SIP format to a form the appliance can understand.

In addition, for full functionality, the Networked Appliance system uses SUBSCRIBE and NOTIFY messages as necessary, which are described in “SIP Event Notification” by Adam Roach, a copy of which can be found at http:/www.ietf.org/intemet-drafts/draft-roach-sip-subscribe-notify-02.txt).

### BRIEF DESCRIPTION OF THE DRAWINGS

The foregoing and other features of the present invention will be more readily apparent from the following detailed description and drawings of an illustrative embodiment of the invention in which:

FIG. 1 is an illustration of a prior art SIP architecture;

FIG. 2 is an illustrative embodiment of the SIP architecture modified to accomplish direct communication with a home Networked Appliance system according to the present invention;

FIG. 3 is an illustrative embodiment of the modified SIP architecture for communication from a client application directly via a gateway proxy to a Networked Appliance system according to the present invention;

FIG. 4 is an illustrative embodiment of the modified SIP architecture for communication from a client application a service provider proxy and a gateway proxy server to a Networked Appliance system according to the present invention;

FIG. 5 is an illustrative embodiment of the functional relationships in the arrangement of FIG. 4 according to an embodiment of the invention;

FIG. 6 is an illustrative embodiment of a physical realization of the functional relationships in the arrangement of FIG. 5 according to an embodiment of the invention;

FIG. 7 is an illustration of message flow in a scenario involving simple access to the home Networked Appliance system by the user from a computer at work according to an embodiment of the invention;

FIG. 8 is an illustration of message flow with re-direction according to an embodiment of the invention;

FIG. 9 is an illustration of message flow in which the status of the temperature is checked according to an embodiment of the invention;

FIG. 10 is an illustration of message flow in which the front door of the home is answered by a user in a car according to an embodiment of the invention;

FIG. 11 is an illustration of message flow for an network-based alarm clock service according to an embodiment of the invention;

FIG. 12 is an illustrative embodiment of the invention showing querying of the capabilities of a Networked Appliance; and

FIG. 13 illustrates the invention utilized for forking services.

### DESCRIPTION OF ILLUSTRATIVE EXEMPLARY EMBODIMENTS

According to the present invention SIP is to be used as the basic architecture to implement remote appliance control. However, before it can be used for this purpose, certain changes must be made. In particular, in SIP, the names that are found in the “To:” and “From:” fields are encoded as Universal Resource Locators (URL). Current implementations support SIP and PHONE URLs. However, a new type of URL must be defined for Networked Appliance systems without changing the nature of the protocol. This new URL type allows for “user friendly” discovery of the appliance address. An example, using the service URL syntax defined in RFC2609; but, without the location information (which has already been determined via the SIP routing) and without the “sip:” prefix would be:

d=lamp,r=bedroom

By base64 encoding this URL (and potentially encrypting it to avoid revealing information about the types of devices contained in the domain) it is possible to structure this URL as part of a SIP URL;

a458fauzu3k3z@stan.home.net

Thus, the existing structure of <entity>@<location> is maintained even when extended to accommodate appliances. However, it is not mandatory to use this proposed type of addressing scheme—a standard SIP URL addressing scheme in either plain text (e.g., toaster@stan.home.net) or with the portion to the left of the @ sign encrypted (e.g., a3245dsfs234@stan.home.net) are also valid addresses that will work. A hierarchical addressing could even be used in standard SIP addressing, e.g., lamp. bedroom@stann.home.net.

SIP was initially created with call set-up in mind. It is designed for establishing a relationship, or session, between two endpoints such that ongoing bearer paths can be established between them. This structure could be generalized for ‘short-lived’ connections if the connection establishment phase of SIP were removed and the SIP payload generalized. The difference between the current way in which SIP is used and the modifications according to the invention is analogous in many ways to the difference between TCP and UDP or other Session/Datagram protocols.

A new method is being defined as part of the initiative to use SIP for Instant Messaging. This method, called DO meets the requirements for Networked Appliance systems and can carry payloads other than Session Description Protocol (SDP), which is the typical MIME payload for the SIP INVITE messages. Unlike standard SIP bodies or payloads that carry communications information, the DO type contains control and query commands specific for directing and receiving status information from Networked Appliances. Any MIME type could be used as the payload of a SIP command and new MIME types could easily be defined for commands or queries (Action Languages) for a particular class of Networked Appliances. An example of this new MIME type is the Device Messaging Protocol (DMP). DMP is an XML-based specification similar to Universal Plug 'n Play's Device Control Protocol. See, UPnP Device Control Protocol, www.upnp.org. Thus, a DO message would carry the command that is appropriate for the target appliance, such as “Turn The Light On,” or a query, such as “What is the temperature.” The command would trigger a single response, indicative of its result, which would be carried by the standard SIP response mechanisms.

In addition, when a device registers with a Proxy (via the REGISTER message) a description of that device must be conveyed. This is achieved with a Device Description Protocol (DDP) to carry this information. Like the DMP, it is XML-based.

The request URI of the DO type request is a normal SIP URL identifying the party to whom the message is directed. There is no need to established a session or connection ahead of time, as may be the case with conventional SIP. The sender places the URL for the desired recipient in the mandatory “To” field. The “From” field identifies the originator of the message. The message must also contain a Call-ID. In SIP, the Call-ID is used to associated a group of requests with the same session.

Each message contains a Cseq, which is a sequence number plus the name of the method of the request. The Cseq uniquely identifies each message in the session, and increases for each subsequent message. Each DO type also carries a “Via header.” Via headers contain a trace of the IP addresses or FQDNs of the system that the request traversed. As a request travels from proxy to proxy toward the recipient, each adds its address, “pushing” them into a header, much like the operation of a stack. The stack of addresses is reflected in the response, and each proxy “pops” the top address off, and uses that to determine where to send the response. Clients using the DO extension must insert a “Contact” header into the request (Contact is used for routing of requests in the reverse direction, from the target of the original message to the initiator of the original message). The message also contains a body. The body contains the message to be rendered by the recipient. SIP uses the standard MIME headers (Content-Type, Content-Length, and Content-Encoding) to identify the content. The request may be sent using UDP or TCP or SCTP transport. Reliability is guaranteed over UDP and congestion control is provided through a simple retransmission.

The SIP DO type has the following format and nine parts:

DO sip: user2@domain.com SIP/2.0

(1) Via:[SIP/2.0/UPD user1pc.domain.com],

(2) From:[sip:user1@domain.com],

(3) To:[sip: user2@domain.com],

(4) Contact:[sip: user1@user1pc.domain.com],

(5) Call-ID:[asd88asd77a@1.2.3.4],

(6) Cseq:[1 MESSAGE]

(7) Content-Type:[text/plain],

(8) Content-Length:[18], and

(9) Body [e.g., “Watson, come here.”].

The portions in square brackets indicate examples of content.

This structure establishes synchronous communication with Networked Appliances. However, it is also necessary to establish asynchronous communications. For example, in order to be notified when an alarm goes off in your home, a certain temperature is reached, or when someone rings your doorbell, the system must be capable of asynchronous communication.

The SIP Instant Messaging system defines two new primitives, SUBSCRIBE and NOTIFY that can be used to achieve asynchronous communications. When these two methods are used in conjunction with the proposed addressing scheme and the Device Messaging Protocol MIME type, then event notification from and between Networked Appliances is enabled.

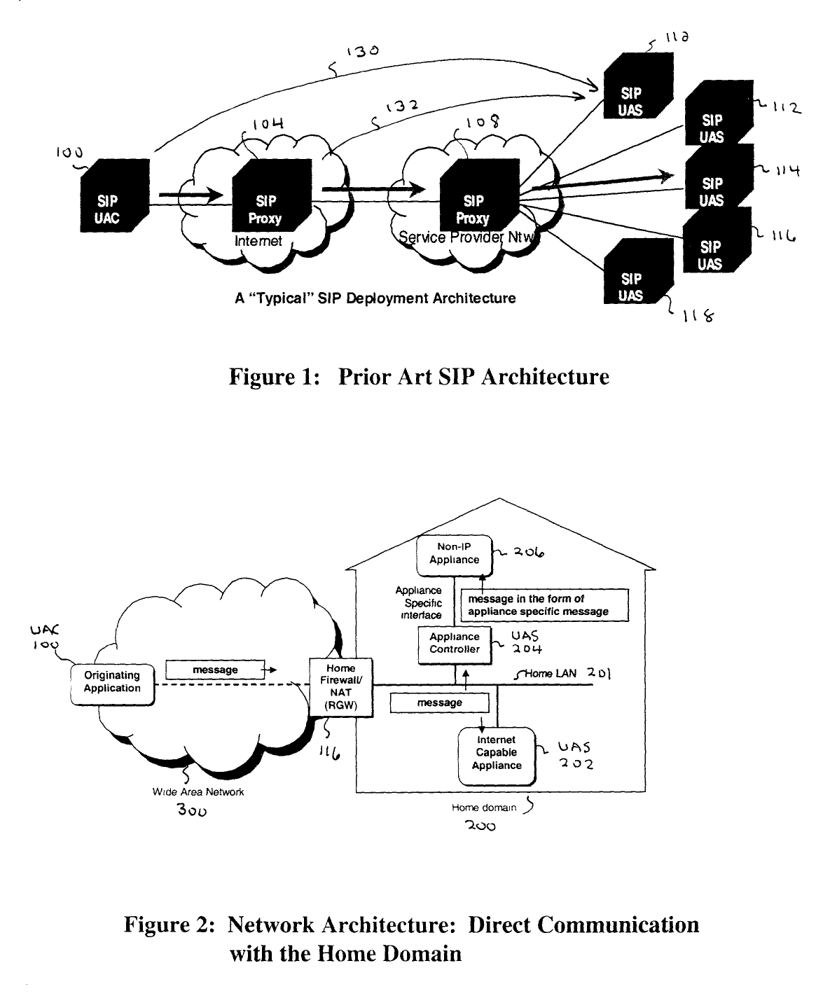

FIG. 1 shows a typical prior art SIP architecture. In this arrangement, a client, e.g., an Internet phone user, employs a SIP User Agent application operating as a client, i.e., SIP UAC 100, to initiate a SIP communication with one or more User Agent Servers (UAS) which may be associated with an intended recipient of an Internet phone call. This system supports three different types of architectures which permit remote communication with networked devices. The actual implementations may use any combination of the three architectures.

In the first arrangement, the client application UAC 100 is able to directly connect to and interact with one of several UAS devices 110, 112, 114, 116 and 118. In this case the client establishes contact directly with the UAS 110 at the recipient via path 130. The second architecture has the client application interact with a SIP proxy 104 in the Internet in order to communicate with networked devices, e.g., Internet phones. In the second architecture, another SIP proxy 104 passes communications from UAC 100 to one of the various SIP UAS devices, e.g. UAS 110, via path 132.

With the third arrangement, the conventional SIP message or request is first routed from UAC 100 to the Internet SIP Proxy server 104, which processes it and sends it to the SIP Proxy server 108. Proxy server 108 is associated with a particular service, e.g., an Internet telephony service. This Proxy 108 then sends the request to one of the several UASs 110, 112, 114, 116, 118 associated with it. Each of the UASs may be at separate locations, e.g., at the homes of individuals selected to receive the messages, and are embedded in or attached to devices, such as a telephone instrument. Assuming the request is for the home associated with SIP UAS 116, the message is delivered to it and the device attached to it. Based on the message, UAS 116 operates the device according to the message.

Before the UAS 116 processes the message and sends the instruction to the device, it must determine that the message was intended for it, and it was sent by an authorized individual. Thus, UAS 116, and all of the other UASs, must check the destination address of the messages, and make sure that the messages are authorized and are in a format it can interpret. Further, the UAS must be able to translate the message into a format that the attached device can understand and respond to.

If the SIP protocol is extended according to the invention to include the DO methods and to take advantage of the SUBSCRIBE and NOTIFY methods, the various SIP architectures can be used to control Networked Appliances. The simplest architecture of the three examples is shown in FIG. 2 and allows a client application to directly connect to and 20 interact with networked devices in the home domain 200. The wide area network 300, e.g. the Internet, is used to carry messages from a client application at SIP UAC 100 to the SIP UAS 116, which is a residential gateway (RGW) in the form of a Home Firewall/Network Address Translator (NAT). Once authenticated, these messages are allowed through the firewall. Inside the home domain 200 messages are transported over the Home LAN 201 to the appropriate Networked Appliance. The devices may either be “IP capable”, i.e., they can process the incoming SIP messages themselves, such as device 202, or Non-IP-capable appliances, such as appliance 206. Non-IP-capable appliances require an appliance controller 204 to translate the SIP control requests to the specific protocol of the appliance.

In many cases, it will not be possible or desirable to allow client applications to directly access and control a user's Networked Appliances. This situation can occur for a number of reasons including:

The Appliance's IP address cannot be determined because it is behind a Network Address Translator (NAT).

The Appliance does not have an IP address.

It is desired to keep the visibility of the in-home devices to a minimum.

It is desired that the Home UAS (i.e., the Firewall/NAT) filter and reject communications from unknown sources for security reasons.

Finer-grained security is desired (i.e. authentication and access control on a per device/message basis).

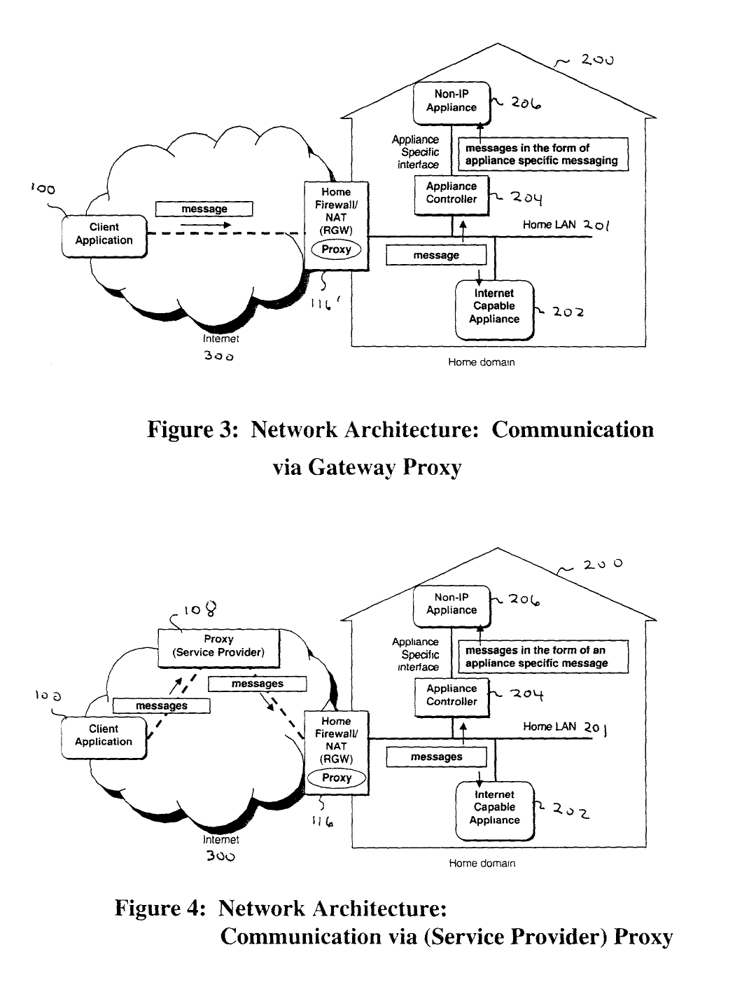

In this case, control messages from UAC client applications must first be sent to a ‘trusted’ Proxy which has visibility into the home. This architecture is the same as in FIG. 2, except that a Proxy server is provided between the client application and the residential gateway (RGW). All communications between the Proxy server and the Home Firewall/NAT are assumed to be secure. In the case, which is shown in FIG. 3, the Proxy server is physically located in the home domain's gateway device 116′. This Proxy server can provide a number of functions including:

Authentication and authorization of each message/request.

Address mapping/resolution for Networked Appliances within the home domain.

Security for the Home Firewall/NAT (RGW) for communications to the outside world.

Networked Appliance mobility and tracking service.

Message protocol mapping for client applications. By taking this approach, a variety of client applications can be supported for remote controlling Networked Appliances.

A charging point for services.

The previous case (i.e., the proxy in the gateway device) requires a lot of functionality in the proxy, which may place onerous requirements on the gateway device in terms of performance, memory, etc. Since gateway devices may not have the resources required to support the proxy functionality previously described, much of the functionality could be moved to an external proxy 108 (e.g., in the Networked Appliance Service Provider's network). This external Proxy 108 could provide all the functionality described in the previous section and, if a secure connection (e.g., IPsec tunnel) exists between the external proxy 108 and the gateway proxy 116′, the gateway proxy is only required to forward the SIP messages to the appropriate UA. The split of functionality in the gateway proxy does not have to be an “all or nothing” decision, but could be split equally (or unequally) between the two proxies. This architecture is depicted in FIG. 4. The advantages of this approach are:

Administration of the SIP Proxy is performed centrally, avoiding a distributed systems issue.

If the local link to the home were to fail, functionality would still be available through the Service Provider Proxy 108 from the wide area 300, e.g. so the system could re-direct messages to another home, for example.

Configuration of the RGW is kept to a minimum, although it may still be necessary to perform some limited configuration such as the creation of an IPsec tunnel.

The costs of making the Service Provider fault tolerant can be amortized across multiple homes.

In the arrangement of FIGS. 2-3, the SIP UAS as shown in FIG. 1 has been considered to be the residential gateway (RGW). However, in an alternative embodiment, the Internet capable appliance 202 and the appliance controller 204 may be considered SIP UAS devices, with the RGW as their proxy server. However, in the arrangement the UAS device would not need address mapping capability, unless for example the controller 204 controlled more than one appliance.

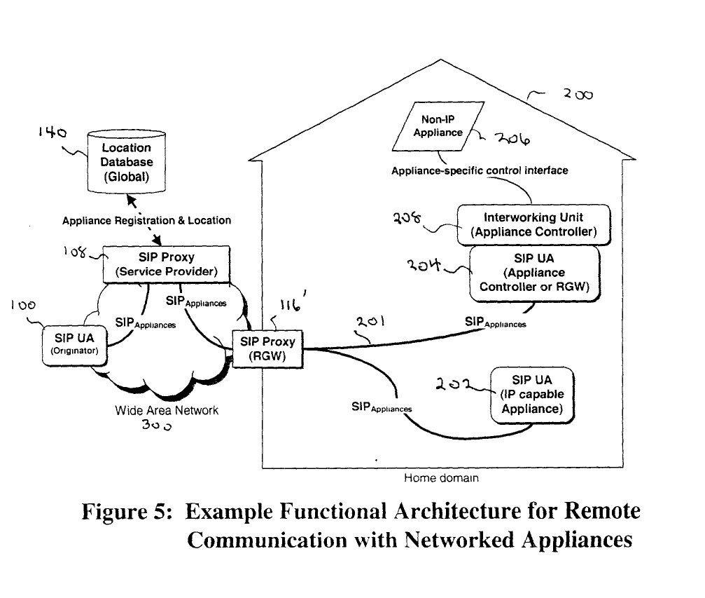

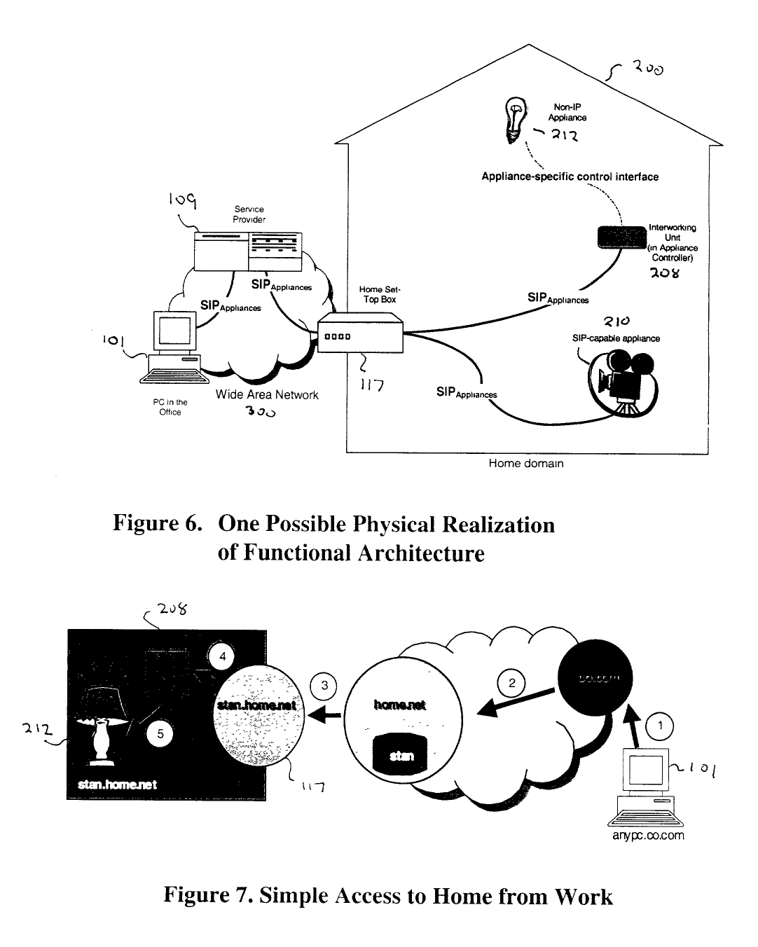

FIG. 5 is a functional representation of the SIP Architecture for supporting Networked Appliances. It is based on the Messaging via Proxy architecture of FIGS. 3 and 4. The functional entities can be distributed across different physical network elements (see FIG. 6). As with the previous descriptions, a request for operation of a Networked Appliance or the status thereof, begins in an originating client application at SIP UAC 100 (originating application). SIP UAC 100 is used by the originating application to generate and send appliance messages (DO) to the SIP Proxy 108 hosted by either the service provider or the home RGW. The SIP proxy 108 in the service provider domain resolves the address of the appliance to be communicated with (including the appropriate Home domain RGW) by means of a lookup in a location database 140. The SIP Proxy forwards appliance messages from the Client SIP UA 100 to the SIP Proxy 116′ in the Home Domain RGW or, via a secure connection, directly to the SIP UAS in the target device.

The location database 140 contains location information for all registered appliances within the home domains. This database is populated with information gathered by the service provider SIP Proxy 108 during a registration procedure. In particular, REGISTER messages are sent to Proxy 108 to register the location of the client and each appliance. In the case of appliances, the registration may merely be that the appliance is in home domain 200. Further, even this may not be registered, only the IP address of home domain 200. In this case the user is expected to know the appliances available in the home domain. If addressed to that domain, a message will be addressed to the appliance by address mapping in Proxy 116′.

The SIP Proxy 116′ in the home domain residential gateway provides the gateway between appliances in the home domain and entities in the wide area network 300. Other RGW functions, such as Firewall and NAT, may be co-located with the RGW SIP Proxy 116′. A SIP UAS terminates SIP appliance messages from the originating application SIP UAC 100. It retrieves messaging information from the SIP message and passes this information to the Interworking Unit 208. This SIP UAS may be a stand alone unit, reside in the RGW 116 or reside in the Appliance Controller 204 as shown in FIG. 5. The logical mapping from SIP UAC to the appliance controller is 1:N, where N is the number of controllers that may be reached over the network by the originating program.

The Interworking Unit 206 maps the appliance message carried in the payload of the SIP message into the appliance-specific protocol. This protocol is in a form that can be interpreted by the non-IP appliances 206 which are thus controlled by the appliance controller 204 through the use of the Interworking Unit 208 in order to communicate/interact with the originating client applications.

The SIP UAS (IP capable appliance) 202 resides in an IP (SIP) capable Networked Appliance. It terminates SIP appliance control messages from the originating application SIP UAC 100, and retrieves the appliance control status information for the appliance application, acting on it directly without any requirement for an intervening Interworking Unit 206 or a appliance controller 204 which are needed for the non-IP appliance.

The key interfaces in FIG. 5 are (1) the SIP Networked Appliances, (2) the appliance registration and location, and (3) the appliance specific interfaces. The SIP appliances interface represents IETF SIP with the DO method for communicating with Networked Appliances. The appliance registration and location interface is achieved with any appropriate database update and lookup protocol which is used to access the location database 140. Examples of such a protocols are LDAP and SLP. Further, the appliance-specific interfaces are numerous home-networking technologies currently available. It is the function of the Interworking Unit 206 to map from SIP to the protocols of the specific technology of the target appliance.

A physical realization of the functional system of FIG. 5 is shown in FIG. 6 where the Originating SIP UAC 100 is on the PC 101 in the user's office. A message is originated from this machine to manipulate an object within the home—perhaps a video camera 210 or a light 212, for example. This message is forwarded, using standard SIP techniques as modified according to the invention, to the Service Provider system 109 (which includes SIP Proxy 108) that is responsible for the home. Provider 109 sends the message to the Set Top Box (STB) 117, which may include a RGW, Cable Modem, ADSL Modem or whatever other appropriate edge of home technology is deployed. The STB 117 sends the message on either directly to the SIP-capable device (which will tend to be devices with higher capabilities, such as video camera 210 and home audio-video equipment), or indirectly via an Interworking Unit 208, which may be part of an appliance controller. With this physical realization the users will not need to be aware of the level and sophistication of the communications that are being performed on their behalf.

The following examples illustrate how SIP coding, modified according to the present invention to include DO types, is used for inter-domain networking of appliances. In this description not all SIP message header fields (e.g. CSeq, Call-ID, and Content-length) are included. For the sake of brevity, only the header fields of particular interest have been included. Also note that the device messaging protocol (DMP) has not yet been standardized and the DMP examples should be considered to be for illustration only.

In the scenario illustrated in FIG. 7, the user wishes to turn on a lamp within his home from his office PC 101. The SIP messages for the remote control (e.g., from the office) of a Networked Appliance within the home (e.g., a lamp) are shown below. Note that the SLP URL information in an actual application would be encoded and optionally encrypted for privacy, but is shown un-encrypted between square brackets for clarity. In this example the user agent, e.g. set top box 117, located in stan.home.net has been registered with stan.home.net and that information has been propagated to home.net. The message numbered “1” below is between the PC and the outbound proxy co.com. It is indicated in FIG. 7 as a “1” in a circle.

1. DO sip:[d=lamp,r=bedroom,u=stanm]@home.net SIP/2.0

From: sip:stan@co.com

To: sip:[d=lamp,r=bedroom,u=stanm]@home.net

Via: SIP/2.0/UDP anypc.co.com

Content-function: render

Content-type: application/dmp

<command><tum>On</turn></command>

The co.com proxy does an SRV look-up in DNS for [d=lamp,r=bedroom,u=stanm]@home.net to find the name of the SIP server for the destination domain and gets a value of home.net. This implies that the user/service name must be unique within the service provider's domain when an SRV record points to a service provider's proxy.

The message “2” in FIG. 7 is from co.com to home.net as follows:

2. DO sip:[d=lamp,r=bedroom,u=stanm]@home.net SIP/2.0

From: sip:stan@co.com

To: sip:[d=lamp,r=bedroom,u=stanm]@home.net

Via: SIP/2.0/UDP co.com

Via: SIP/2.0/UDP anypc.co.com

Content-function: render

Content-type: application/dmp

<command><tum>On</tum></command>

The message from home.net to stan.home.net (which may be set top box 117) is:

3. DO sip:[d=lamp,r=bedroom,u=stanm]@stan.home.net SIP/2.0

From: sip:stan@co.com

To: sip:[d=lamp,r=bedroom,u=stanm]@home.net

Via: SIP/2.0/UDP home.net

Via: SIP/2.0/UDP co.com

Via: SIP/2.0/UDP anypc.co.comContent-function: render

Content-type: application/dmp

<command><tum>On</turn></command>

From the set top box 117 to Interworking Unit 208 the message is:

4. DO sip:[d=lamp,r=bedroom,u=stanm]@ua.stan.home.net SIP/2.0

From: sip:stan@co.com

To: sip:[d=lamp,r=bedroom,u=stanm]@home.net

Via: SIP/2.0/UDP stan.home.net

Via: SIP/2.0/UDP home.net

Via: SIP/2.0/UDP co.com

Via: SIP/2.0/UDP anypc.co.com

Content-function: render

Content-type: application/dmp

<command><turn>On</tum></command>

Finally, the Interworking Unit sends an action message to lamp 212 to cause the lamp to turn on as follows:

5. <Action!!!>

The above scenario could also be used to depict a failure scenario. Once the lamp receives the message, it may realize that its bulb is “blown” (broken) and in response sendS something like:

6. SIP/2.0 503 Service Unavailable

From: sip:stan@co.com

To: sip:[d=lamp,r=bedroom,u=stanm]@home.net

Via: SIP/2.0/UDP stan.home.net

Via: SIP/2.0/UDP co.com

Via: SIP/2.0/UDP anypc.co.com

Content-function: render

Content-type: application/text

Bulb has blown !! Replace with new!

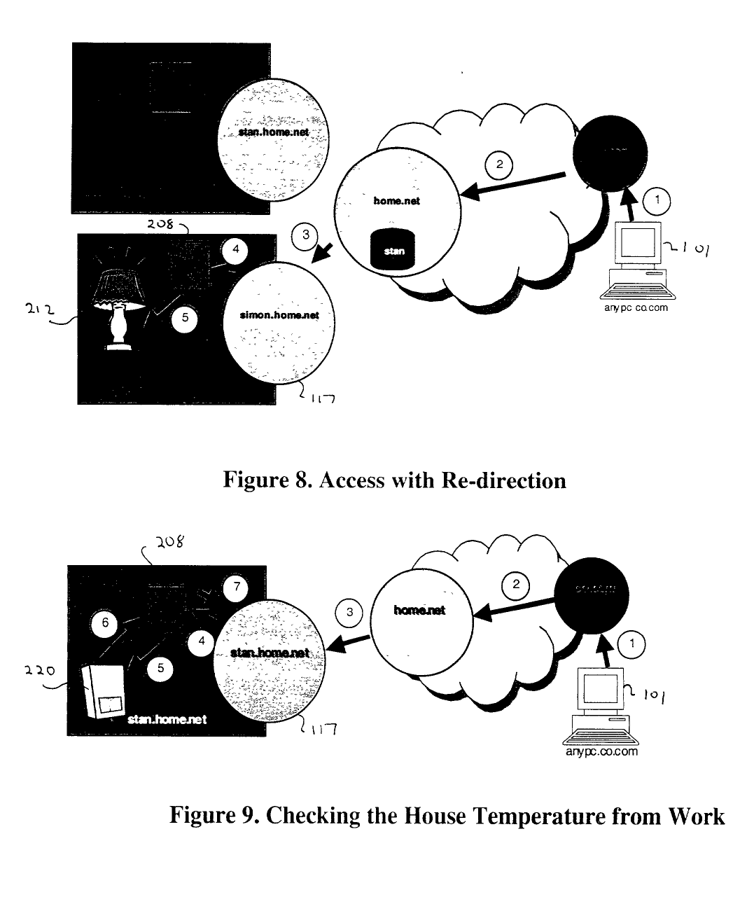

In the case illustrated in FIG. 8 the lamp from stan.home.net has temporarily been moved to simon.home.net. To accommodate the change, a re-direction is added into the home.net proxy. The SIP MESSAGES for this scenario are shown below. In this example, the lamp from stan.home.net has been unregistered with both stan.home.net and home.net and the User Agent in simon.home.net has performed the appropriate registrations.

1. DO sip:[d=lamp,r=bedroom,u=stanm]@home.net SIP/2.0

From: sip:stan@co.com

To: sip:[d=lamp,r=bedroom,u=stanm]@home.net

Via: SIP/2.0/UDP anypc.co.com

Content-function: render

Content-type: application/dmp<command><tum>On</tum></command>

Notice this message is still directed to stan.home, even though the lamp is now at Simon's home.

2. DO sip:[d=lamp,r=bedroom,u=stanm]@home.net SIP/2.0

From: sip:stan@co.com

To: sip:[sip://d=lamp,r=bedroom,u=stanm]@home.net

Via: SIP/2.0/UDP co.com

Via: SIP/2.0/UDP anypc.co.com

Content-function: render

Content-type: application/dmp

<command><turn>On</tum></command>

The home.net proxy does a look-up and notices that Stan's bedroom lamp is now in Simon's spare room. Therefore, the Request-URI now points to the spare room in Simon's house.

3. DOsip:[d=lamp,r=spareroom,u=stanm]@simon.home.net SIP/2.0

From: sip:stan@co.com

To: sip: [d=lamp,r=bedroom,u=stanm]@home.net

Via: SIP/2.0/UDP home.net

Via: SIP/2.0/UDP co.com

Via: SIP/2.0/UDP anypc.co.comContent-function: render

Content-type: application/dmp

<command><tum>On</turn></command>

4. DO sip:[d=lamp,r=bedroom,u=stanm]@ua.simon.home.net SIP/2.0

From: sip:stan@co.com

To: sip:[slp://d=lamp,r=bedroom,u=stanm]@home.net

Via: SIP/2.0/UDP simon.home.net

Via: SIP p/2.0/UDP home.net

Via: SIP/2.0/UDP co.com

Via: SIP/2.0/UDP anypc.co.com

Content-function: render

Content-type: application/dmp

<command><turn>On</turn></command>

5. <Action!!!>

In the scenario of FIG. 9, Stan is at work at his p.c. 101 and wants to check the temperature of the downstairs zone of his two-zone heating and cooling system in his home. He has been trying to determine the right combination of upstairs and downstairs thermostat settings to get the house to the desired temperature. Stan is an engineer.

Instead of “lamp” the DO message now designates the “downstairs” “thermostat” at Stan's house. Also, in the body the action is now “query” instead of “command”.

1. DO sip:[d=thennostat,r=downstairs,u=stanm]@home.net SIP/2.0

From: sip:stan@co.com

To: sip:[d=thennostat,r=downstairs,u=stanm]@home.net

Via: SIP/2.0/UDP anypc.co.com

Content-type: application/dmp

<query>Temperature</query>

2. DO sip:[d=thermostat,r=downstairs,u=stanm]@home.net SIP/2.0

From: sip:stan@co.com

To: sip: [d=thermostat,r=downstairs,u=stanm]@home.net

Via: SIP/2.0/UDP co.com

Via: SIP/2.0/UDP anypc.co.com

Content-type: application/dmp

<query>Temperature<query>

3. DO sip:[d=thermostat,r=downstairs,u=stanm]@stan.home.net SIP/2.0

From: sip:stan@co.com

To: sip: [d=thermostat,r=downstairs,u=stanm]@home.net

Via: SIP/2.0/UDP home.netVia: SIP/2.0/UDP co.com

Via: SIP/2.0/UDP anypc.co.com

Content-type: application/dmp

<query>Temperature</query>

4. DO sip:[d=thennostat,r=downstairs,u=stanm]@ua.stan.home.net SIP/2.0

From: sip:stan@co.com

To: sip:[d=thermostat,r=downstairs,u=stanm]@home.net

Via: SIP/2.0/UDP stan.home.net

Via: SIP/2.0/UDP home.net

Via: SIP/2.0/UDP co.com

Via: SIP/2.0/UDP anypc.co.com

Content-type: application/dmp

<query>Temperature</query>

5. <Query!!!>

6. The current temperature reading is returned to the UA.

7. 200 stan@co.com

From: sip:[d=thermostat,r=downstairs,u=stanm]@home.net To: sip:stan@co.com

Via: SIP/2.0/UDP stan.home.net

Via: SIP/2.0/UDP home.net

Via: SIP/2.0/UDP co.com

Via: SIP/2.0/UDP anypc.co.com

Content-type: application/dmp

<temperature>65F</temperature>

This message is forwarded to the request originator on anypc.co.com)

The main differences between this example and the previous examples are:

a different body to issue a query for the temperature instead of a command to turn on the light

the removal of the Content-function header field since “render” is the default value for this header field in a DO method (this is optional and it could have been left in).

After Stan receives the temperature, he could issue another command to set the desired temperature. This would use a similar DO message with a different body content. These messages back and forth between Stan and the thermostat are part of a single SIP session, where instead of a telephone call or a video conference, appliances commands and status information are exchanged.

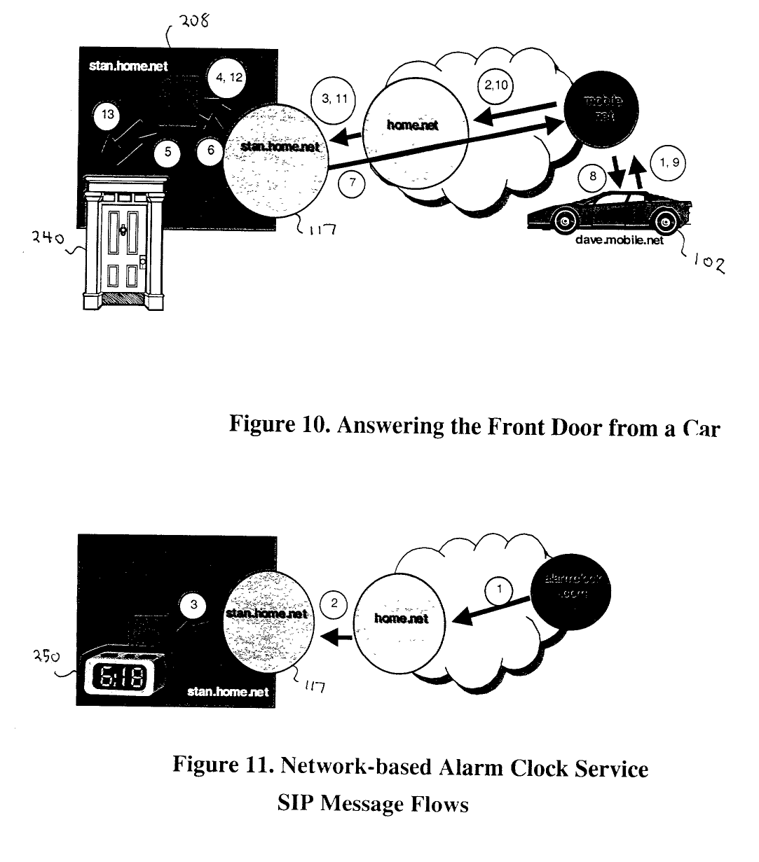

In the example of FIG. 10, Stan is riding with Dave in Dave's car and remembers that he was expecting a service person to come and fix the dishwasher and he does not have his Web phone. He asks to borrow Dave's phone and sends a message to his service provider 109 to notify him if someone “rings” the doorbell. Stan sends an authentication code to the service provider when prompted to do so. This code will be attached to the message to verify that it is Stan not Dave who is requesting the access to the home domain.

When the service person “rings” the doorbell (and authenticates themselves with their ID badge or a password entered on a keypad for this purpose), a message is sent to Dave's Web phone for Stan indicating that the service person is at the front door. After verifying that it is indeed a person from the right company, Stan issues a command to unlock the front door and let the person in.

In this scenario, it is assumed that device controller UA 208 is configured to send outbound messages to a Proxy at Stan.home.net and that Dave's UA 102 is configured to send outbound messages to a Proxy at mobile.net. The message starts with a SUBSCRIBE instead of a DO to connect to the mobile.net. Also, the front door is noted in the message.

1. SUBSCRIBE sip:[d=door,r=front,u=stanm]@home.net SIP/2.0

From: sip:stanm@dave.mobile.net

To: sip:[d=door,r=front,u=stanm]@home.net

Via: SIP/2.0/UDDP dave.mobile.net

Contact: sip;stanm@dave.mobile.net

Content-type: application/dmp

<event>ring</event>

2. SUBSCRIBE sip:[d=door,r=front;u=stanm]@home.net SIP/2.0

From: sip:stanm@dave.mobile.net

To: sip:[d=door,r=front,u=stanm]@home.net

Via: SIP/2.0/UDP mobile.net

Via: SIP/2.0/UDP dave.mobile.net

Contact: sip:stanm@dave.mobile.net

Content-type: application/dmp

<event>ring</event>

3. SUBSCRIBE sip:[d=door,r=front,u =stanm]@stan.home.net SIP/2.0

From: sip:stanm@dave.mobile.net

To: sip:[d=door,r=front,u=stanm]@home.net

Via: SIP/2.0/UDP home.net

Via: SIP/2.0/UDP mobile.net

Via: SIP/2.0/UDP dave.mobile.net

Contact: sip;stanm@dave.mobile.net

Content-type: application/dmp

<event>ring</event>

4. SUBSCRIBE sip:[d=door,r=front,u=stanm]@ua.stan.home.net SIP/2.0

From: sip:stanm@dave.mobile.netTo: sip:[d=door,r=front,u=stanm]@home.net

Via: SIP/2.0/UDP stan.home.net

Via: SIP/2.0/UDP home.net

Via: SIP:2.0/UDP mobile.net

Via: SIP/2.0/UDP dave.mobile.net

Contact: sip:stanm@dave.mobile.net

Content-type: application/dmp

<event>ring</event>

5. (Doorbell Rings! Credentials established.)

Since Stan has requested that he be notified when the door bell rings, the UA, upon detection of the ring, formulates a SIP NOTIFY message for Stan in Dave's car.

6. NOTIFY stanm@dave.mobile.net SIP/2.0

From: sip:[d=door,r=front,u=stanm]@stan.home.net

To: stanm@dave.mobile.net

Via: SIP/2.0/UDP ua.stan.home.net

Content-type: application/dmp

<event>ring</event>

<identity>Maytag Repairman</identity>

7. NOTIFY stanm@mobile.net SIP/2.0

From: sip:[d=door,r=front,u=stanm]@stan.home.net

To: stanm@dave.mobile.net

Via: SIP/2.0/UDP stan.home.net

Via: SIP/2.0/UDP ua.stan.home.net

Content-type: application/dmp

<event>ring</event>

<identity>Maytag Repairman</identity>

8. NOTIFY stanm@dave.mobile.net SIP/2.0

From: sip:[d=door,r=front,u=stanm]@stan.home.net

To: stanm@dave.mobile.net

Via: SIP/2.0/UDP mobile.net

Via: SIP/2.0/UDP stan.home.net

Via: SIP/2.0/UDP ua.stan.home.net

Content-type: application/dmp

<event>ring</event>

<identity>Maytag Repairman</identity>

Stan has now been alerted that the serviceman is at the door. He decides to unlock the door and sends a DO command to the door lock to unlock the door.

9. DO sip:[d=door,r=front,u=stanm]@home.net SIP/2.0

From: sip:stan@dave.mobile.net

To: sip:[d=door,r=front,u=stanm]@home.net

Via: SIP/2.0/UDP dave.mobile.net

Content-type: applicationldmp

<command>unlock</command>

10. DO sip:[d=door,r=front,u=stanm]@home.net SIP/2.0

From: sip:stan @dave.mobile.net

To: sip:[d=door,r=front,u=stanm]@home.net

Via: SIP/2.0/UDP mobile.net

Via: SIP/2.0/UDP dave.mobile.net

Content-type: application/dmp

<command>unlock</command>

11. DO sip:[d=door,r=front,u=stanm]@stan.home.net SIP/2.0

From: sip:stan@dave.mobile.net

To: sip:[d=door,r=front,u=stanm]@home.net

Via: SIP/2.0/UDP home.net

Via: SIP/2.0/UDP mobile.net

Via: SIP/2.0/UDP dave.mobile.netContent-type: application/dmp

<command>unlock</command>

12. DO sip:[d=door,r=front,u=stanm]@ua.stan.home.net SIP/2.0

From: sip:stan@dave.mobile.net

To: sip: sip:[=door,r=front,u=stanm]@home.net

Via: SIP/2.0/UDP stan.home.net

Via: SIP/2.0/UDP home.net

Via: SIP/2.0/UDP mobile.net

Via: SIP/2.0/UDP dave.mobile.net

Content-type: application/dmp

<command>unlock</command>

13. <Unlock!!!>

The previous application scenarios of FIGS. 7 and 8 involved communications outside of session. However, it may be necessary to establish sessions with networked appliances. For example, consider an Internet Alarm Clock service where your wake-up time is adjusted based on current weather, road, and traffic conditions. If the network-based alarm clock service provider adjusts your wake-up time, you would want to know why. So, it would be convenient for the alarm clock service provider to establish an audio session with your alarm clock and “play” a message containing the reason(s) for the adjusted wake-up time (and maybe include the current weather, top news stories, etc.). The message flow for this scenario (depicted in FIG. 11) would be as follows:

1. INVITE sip:[d=alarm clock,r=bedroom]@home.net SIP/2.0

From: sip:announcement@alarmclock.com

To: sip:[d=lamp,r=bedroom]@stan.home.net

Via: SIP/2.0/UDP alarmclock.com

Content-type: application/sdp

[SDP Parameters for unidirectional RTP stream]

2. INVITE sip:[d=alarm clock,r=bedroom]@stan.home.net SIP/2.0

From: sip:announcement@alarmclock.com

To: sip:[d=lamp,r=bedroom]@stan.home.net

Via: SIP/2.0/UDP home.net

Via: SIP/2.0/UDP alarmclock.com

Content-type: application/sdp

[SDP Parameters for unidirectional RTP stream]

3. INVITE sip:[d=alarm clock,r=bedroom]@ua.stan.home.net SIP/2.0

From: sip: announcement@alarmclock.com

To: sip: sip:[d=lamp,r=bedroom]@stan.home.netVia: SIP/2.0/UDP stan.home.net

Via: SIP/2.0/UDP home.net

Via: SP/2.0/UDP alarmclock.com

Content-type: application/sdp

[SDP Parameters for unidirectional RTP stream]

A response is then returned to the alarm clock service provider with the alarm clock's RTP parameters and an audio RTP stream is initiated (sent to the alarm clock).

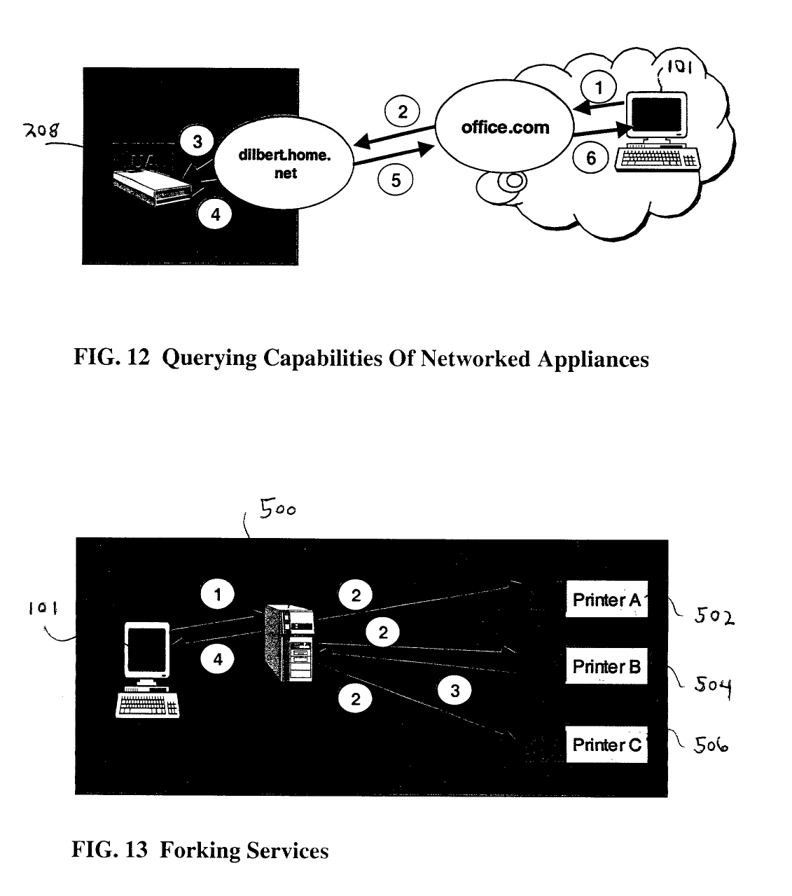

In the next scenario, assume that Wally's VCR broke down a few days ago. Today is Saturday and Wally wants to record “The Simpson's” cartoon show. He walks up to his office colleague Dilbert, who gives him permission to use his VCR to record the show. Wally knows Dilbert's VCR is a Sony Model, but does not know if it supports preprogrammed pause and resume for recording (to avoid commercial advertisements). In the arrangement of FIG. 12, Wally from the office p.c. 101 queries the VCR connected to UA 208 at Dilbert's Home to determine its set of capabilities. Wally receives a response from the VCR telling him which video package this particular VCR supports, as well as more detailed information about the VCR.

The following SIP messages are sent to accomplish this query of a Networked Appliance's capabilities.

1. OPTIONS sip:[d=vcr,r=den]@office.net SIP/2.0

From: sip:wally@office.com

To: sip:[d=vcr,r=den@dilbert.home.netVia: SIP/2.0/UDP wallyville.office.com

2. OPTIONS sip:[d=vcr,r=den]@dilbert.home.net SIP/2.0

From: sip:wally@office.com

To: sip:[d=vcr,r=den@dilbert.home.net

Via: SIP/2.0/UDP office.com

Via: SIP/2.0/UDP wallyville.office.com

2. OPTIONS sip:[d=vcr,r=den]@dilbert.home.net SIP/2.0

From: sip:wally@office.com

To: sip:[d=vcr,r=den@dilbert.home.net

Via: SIP/2.0/UDP dilbert.home.net

Via: SIP/2.0/UDP office.com

Via: SIP/2.0/UDP wallyville.office.com

2. SIP/2.0 200 OK

From: sip:wally@office.com

To: sip:[d=vcr,r=den@dilbert.home.net

Via: SIP/2.0/UDP dilbert.home.net

Via: SIP/2.0/UDP office.com

Via: SIP/2.0/UDP wallyville.office.com

Supported: com.sony.videopack.mm-extensions

Content-Type:application/ddp

<XML tagged body describing the video control package downloaded in this VCR in more details>

2. SIP/2.0 200 OK

From: sip:wally@office.com

To: sip: [d=vcr,r=den@dilbert.home.net

Via: SIP/2.0/UDP office.com

Via: SIP/2.0/UDP wallyville.office.com

Supported: com.sony.videopack.mm-extensions

Content-Type:application/ddp

<XML tagged body describing the video control package downloaded in this VCR in more details>

2. SIP/2.0 200 OK

From: sip:wally@office.com

To: sip:[d=vcr,r=den@dilbert.home.net

Via: SIP/2.0/UDP wallyville.office.com

Supported: com.sony.videopack.mm-extensions

Content-Type:application/ddp

<XML tagged body describing the video control package downloaded in this VCR in more details>

In a further scenario, as shown in FIG. 13, Calvin wants to print a document in his office from his p.c. 101. There are three printers 502, 504, 506 on different floors that are capable of printing his document. Calvin contacts the default proxy server 500, which forks this request to the different printers. The available printer responds and Calvin CANCELS the other pending requests. For the sake of this example, it is assumed that Calvin wants to establish a session with an available printer to which he will send the data once a confirmation is received. The messages are as follows:

1. INVITE sip:anyprinter@office.com SIP/2.0

From: sip:calvin@office.com

To: sip:anyprinter@ office.com

Via: SIP/2.0/UDP calvin.office.com

1. Proxy forks the following messages:

INVITE sip:printera@office.com SIP/2.0

From: sip:calvin@office.com

To: sip:anyprinter@office.com

Via: SIP/2.0/UDP hobbesproxy.office.com

Via: SIP/2.0/UDP calvin.office.com

INVITE sip:printerb@office.com SIP/2.0

From: sip:calvin@office.com

To: sip:anyprinter@office.com

Via: SIP/2.0/UDP hobbesproxy.office.com; branch=a1234

Via: SIP/2.0/UDP calvin.office.com

INVITE sip:printerc@office.com SIP/2.0

From: sip:calvin=office.com

To: sip:anyprinter@office.com

Via: SIP/2.0/UDP hobbesproxy.office.com; branch=a1234

Via: SIP/2.0/UDP calvin.office.com

wPrinter B responds with OK

w SIP/2.0 200 OK

From: sip:calvin@office.com

To: sip:anyprinter@office.com

Via: SIP/2.0/UDP hobbesproxy.office.com; branch=a1234

Via: SIP/2.0/UDP calvin.office.com

wSIP/2.0 200 OK

From: sip:calvin@office.com

To: sip:anyprinter@office.com

Via: SIP/2.0/UDP calvin.office.com

Proxy now proceeds to CANCEL all other pending requests.

SIP can also allow personal and group device identification. For example, using SIP, an air conditioner in Hagar's home domain could be addressed by the nickname of “coolboy” and at the same time also be known as a category of “air conditioner.” This serves a two-fold purpose, i.e., it allows owners to allocate personalities to their devices as well as, if needed, address a group irrespective of their nicknames. For example, to set the temperature of “coolboy” to 25 degrees C., Hagar can send

1. DO sip:[d=coolboy,r=room,u=hagar]@hagar.home.net SIP/2.0

From: sip:hagar@vacation.com

To: sip:[d=coolboy,r=room,u=hagar]@hagar.home.net

Via: SIP/2.0/UDP vacation.com

Content-type: application/dmp

<command>

Temperature

<set> 25C </set>

</command>

At the same time, if Hagar wanted to switch off all air conditioners in his house, he could multicast or broadcast the command.

1. DO sip:[group=airconditioner, u=hagar]@hagar.home.net SIP/2.0

From: sip:hagar@vacation.com

To: sip:[group=airconditioner, u=hagar]@hagar.home.net

Via: SIP/2.0/UDP vacation.com

Content-type: application/dmp

<command>

Off

</command>

All network aware devices may be configured to be a part of a group. For example, various air conditioner vendors may have their own schemes of private naming, but they all know they belong to the “ac-group” of devices. Therefore, when such a message arrives, they know they are a part of it. Alternately, it is possible that a central Proxy or Appliance Controller is configured by the user or vendor of device groups in his house and once such a message arrives at the Proxy/Controller, it sends an appropriate DO command to each device in this group.

Security is a primary concern, especially since this system is intended for deployment in individual user's homes. The security threats that are applicable to the protocol described herein, and which must be considered in any implementation of this protocol, are various. These include the physical security of the user's home and other conventional security issues. However, this system also raises new security concerns in that via the Internet an adversary can eavesdrop on SIP messages, forge SIP messages, and modify SIP messages, all of which can have important effects in the user's home.

Security concerns must be paramount when designing a system which allows remote access to a home. A forged (generic) SIP message will usually be no more than an annoyance, but a forged command to turn on an appliance within someone else's home is a potential disaster. Therefore, methods for verifying the authenticity of the message must be provided in any system that allows remote home access. In particular, all (SIP) communication to the home must be authenticated by the home RGW/firewall, and verified to have originated from either an authorized individual (in the case of direct communication from user to the home, as in FIG. 3) or an authorized Service Provider Proxy (in the case of communication via proxy, as in FIG. 4). In the second case, the Service Provider Proxy also must have verified that the communication originated from an individual authorized to communicate with the home.

Privacy is also a concern for many users, particularly since messages contain information about the existence and use of appliances within their home. Thus, implementations must provide methods for private (i.e., encrypted) communication.

The security of message responses is also important. These responses may eventually contain status information (i.e., the current temperature of the house, and faked standard 100 and 200 type response messages can also cause problems.

In general, a user will not want a passive eavesdropper to be able to determine the content of a message. This applies not only to the body of the message (which will contain the command to be executed), but also to header fields which may leak information about the devices one owns. For example, the “To:” header field will contain a URL of the addressed entity which, will indicate the device type and location. A user may not want anyone to know whether he owns a television, and he certainly would not want anyone to know the room in which the television is located.

If the underlying architecture being implemented provides direct control of the home domain, no intermediate proxies need be trusted (with respect to privacy) because appropriate fields can be suitably encrypted. However, if the underlying architecture is Communication via Proxy (FIG. 4), an assumption of trust in the intervening Service Provider Proxy is inevitable.

REGISTER messages may also require encryption, if registration takes place in a network outside the home (as it would in the case of Communication via Proxy (FIG. 4)).

From the user's point of view, an even more important concern is proper authentication of SIP messages. Note that messages in either direction (from user to home, or from home to user) require authentication. The authentication requirement on messages from user to home is obvious, since these are messages which will effect certain actions inside the home. However, 100 and 200 type response messages from the home to the user must also be authenticated, lest an adversary insert a fake Acknowledge or Confirmed message when in fact the original message was never received. Also, responses may eventually include status information, such as the temperature of the house or whether the alarm system is turned on.

In addition to authentication of DO type messages, REGISTER type messages may also potentially require authentication. However, if registration is done with the home RGW (as would be the case when direct communication (FIG. 3) is assumed), cryptographic solutions are not necessary (due to the physical security of the home network). When registration takes place in an outside network (as when Communication via Proxy is used), these messages must be authenticated.

Authentication of messages will prevent fabrication, modification, and masquerading. An issue not directly resolved by authentication is replay attacks. Replay attacks can be defended against in two ways. One simple way to do this is to check for repeated messages; this can be done, for example, by checking the Timestamp: or Cseq: fields against previously stored messages. However, there is a limit to the number of previously used Timestamps that can be stored, and this leaves open the possibility of replaying a (very) old message. A more robust solution is to check for old messages by comparing the Timestamp field to the current system time. Note that the Timestamp field cannot be maliciously modified because of the assumed message authentication being used. In this case, however, some synchronization of clocks is assumed

Methods for achieving privacy and authentication for (generic) SIP messages appear in M. Handley, H. Schulzrinne, E. Schooler, and J. Rosenberg, “SIP: session initiation protocol,” Request for Comments (Proposed Standard) 2543, Internet Engineering Task Force, March 1999, and, in general, these methods apply to the case of addressing Networked Appliances (NAs) as well. However, there are a few important differences between general SIP security and the specific case of remote home access.

For general SIP security, some form of public-key technology must be employed to provide security according to the Handley et al. proposal. In the case of remote access to NAs within the home; however, shared secrets can be used to provide privacy and authentication. There are two primary reasons for this difference: first, general SIP communication can potentially occur between any two parties, while in the case of remote access to the home a one-to-one (or few-to-one) correspondence exists between authorized users and the homes to which they will be communicating. Second, general SIP communication frequently occurs between parties who have had no prior contact, and therefore no opportunity to generate a shared secret. In the case of home access, however, users will have the opportunity to designate a shared secret for use in their communication with the home. The secret may be shared either with the home RGW/firewall (in the case of direct communication from user to the home, as in FIG. 1) or with the Service Provider Proxy (in the case of Communication via Proxy, as in FIG. 4).

In general, secret-key methods are preferable to public-key methods due to both their higher level of security and increased efficiency. In some cases, public-key methods may be preferable. It may be advantageous to provide implementations for both. Implementation details will depend on outside factors including the requirements of the Service Provider, initial installation, billing, record keeping, supported remote access methods, and future upgradability.

The SIP RFC in the Handley et al. proposal describes two methods of achieving privacy: encrypt end-to-end or hop-by-hop. In the particular setting of remote access to the home, end-to-end encryption is preferred. End-to-end encryption is certainly more efficient, and if the user and the home RGW/firewall (or Service Provider Proxy) share a secret key, there is no need to rely on hop-by-hop encryption. Furthermore, hop-by-hop encryption requires trust in every proxy along the message path, while end-to-end encryption only requires trust in the final UA which performs the decryption (either the home RGW/firewall or the Service Provider Proxy).

First, as in FIG. 3, there may be direct communication from the user to the home where decryption and verification of authenticity are done by the home RGW/firewall. In this case, the original message from the user can be encrypted and authenticated using the secret key shared by the user and the home.

In the second case, as in FIG. 4, communication is via a Service Provider Proxy. In this scenario, the message from the user is first encrypted and authenticated using a key shared between the user and the Service Provider Proxy. Upon receipt of the message, the Service Provider Proxy verifies the authenticity of the message and decrypts it. Then, the message is authenticated and encrypted using a key shared between the Service Provider Proxy and the home and forwarded to the home (note that this step may also be handled by the establishment of a secure IPSec tunnel between the Service Provider Proxy and the home). The forwarded message is authenticated (as having come from the Service Provider Proxy) and decrypted by the home RGW/firewall before being allowed inside the home.

One major difference between this proposal and Handley et al. proposal is that the “To:” header field now contains potentially sensitive information (such as device names and locations) which should be encrypted. The body of the message (and appropriate header fields) should be encrypted as detailed in Handley et al. proposal (although possibly using private-key technology). Encryption of the “To:” field should take place separately from encryption of the body of the message. Since the entire contents of the To: field cannot be encrypted (this information is used for routing), only the portion to the left of the “@” (the entity information) should be encrypted.

At first glance, this might appear problematic since routing is done based on entity information contained in the To: field. However, this problem is easily avoided. Indeed, routing is done based on two components of the To: field: the entity name (appearing to the left of the “@”) and the location (appearing to the right of the “@”). Information about the location component (typically domain-names) is available to every proxy in the network. On the other hand, information about specific entities is (typically) only available to a select few proxies (in particular, the home RGW/firewall when assuming direct communication from the user to the home, or the Service Provider Proxy when assuming communication via proxy). Thus, for most proxies, routing will be based solely on the location component of the To: field, and these proxies therefore have no need to examine the entity component. On the other hand, proxies that do need to see the contents of the entity component will have the decryption key available to them (since the encryption was done with the appropriate shared key). Thus, routing will proceed via the location component until the message reaches a proxy that has access to information concerning specific devices within that domain. This proxy, by construction, will also have access to the correct key for decrypting (and authenticating) the message. Upon decrypting the message, and in particular the entity component of the To: field, the proxy can correctly route the message using this additional information.

SIP, with the newly proposed DO type, and the SUBSCRIBE and NOTIFY messages developed for Instant Messaging, plus the new MIME types, and new mechanism for encoding service information in the “To:” field can provide the support necessary for communication with Networked Appliances from a wide area network. This enables leveraging the existing SIP infrastructure and capabilities (e.g., hop-by-hop routing and security) for a new problem domain—Networked Appliances.

While the invention has been particularly shown and described with reference to a preferred embodiment thereof, it will be understood by those skilled in the art that various changes in form and details may be made therein without departing from the spirit and scope of the invention.

We claim:

1. A session initiated protocol (SIP) system for communications between a client and at least one networked appliance, comprising:
a user agent server (UAS) processor connected to said appliance so as to relay commands to said appliance and receive status information from said appliance;
a user agent client (UAC) processor having the capacity to send to said UAS processor over a communications network SIP command messages intended for said appliance and to receive status information messages about said appliance from said UAS processor, said UAS processor translating received SIP commands into commands recognized by the appliance and translating information provided by said appliance into SIP status messages for transmission over the communications network to said UAC processor; and
wherein the SIP command message includes a universal resource locator (URL) without location information otherwise specified in the SIP message and the command message has a generalized payload body with at least one of control and query instructions specific to appliances.

2. The session initiated protocol (SIP) system of claim 1, wherein the command message is a SIP message type that has the connection established phase removed.

3. The session initiated protocol (SIP) system of claim 1, wherein the command message is a SIP DO type.

4. The session initiated protocol (SIP) system of claim 1, wherein the command message payload is a device messaging protocol (DMP) MIME type.

5. The session initiated protocol (SIP) system of claim 1, wherein when the command message is a SIP INVITE type, it includes a description of said appliance.

6. The session initiated protocol (SIP) system of claim 1, wherein the appliance is SIP enabled so that it can interpret signals directly from said UAS processor.

7. The session initiated protocol (SIP) system of claim 1, further including an appliance controller located between said UAS processor and said appliance, said controller translating commands from said UAS processor into signals which control operation of said appliance and translating status signals from said appliance into signals which can be translated by said UAS processor.

8. A session initiated protocol (SIP) system for communications between a client and at least one of a plurality of networked appliance in one geographic region, comprising:
a user agent server (UAS) processor connected by a local area network to at least two of said appliances, said UAS processor having address mapping capability so as to direct commands to a selected at least one of said at least two appliances and receive status information from said at least one appliance;
a user agent client (UAC) processor having the capacity to send to said UAS processor over a communications network SIP command messages intended for said at least one appliance and to receive status information messages about said at least one appliance from said UAS processor, said UAS processor translating received SIP commands into commands recognized by said at least one appliance and translating information provided by said at least one appliance into SIP status messages for transmission over the communications network to said UAC processor; and
wherein the SIP command message includes a universal resource locator (URL) without location information otherwise specified in the SIP message, the command message identifies the appliance to which the message is addressed and the command message has a generalized payload body with at least one of control and query instructions specific to appliances.

9. The session initiated protocol (SIP) system of claim 8, wherein the status information from each of the plurality of appliances identifies the appliance from which it originated, and the address mapping of the UAS processor includes an identification of the appliance in the SIP status messages sent to said UAC.

10. The session initiated protocol (SIP) system of claim 8, wherein there are a plurality of locations, each with a plurality of networked appliances, and each location is serviced by a different UAS connected to the plurality of appliances in that location.

11. The session initiated protocol (SIP) system of claim 10, wherein the signals from and to the UAC processor from the plurality of UAS processors pass through at least one proxy server.

12. The session initiated protocol (SIP) system of claim 1,
wherein there are a plurality of geographic locations, each with a plurality of networked appliances;
wherein there are a plurality of UAS processors each servicing a separate one of said locations and being connected to the plurality of appliance in that location, the networked appliances at a location being connected only to the associated UAS processor and not to each other;
wherein the UAS processors do not have address mapping capability for handling messages to and from the appliances; and
further including at least one proxy server connected to least two of said UAS processors, said proxy server having address mapping capability to direct messages through the appropriate UAS processor to the appliance to which they are addressed.

13. The session initiated protocol (SIP) system of claim 1 further utilizing SIP INVITE, SUBSCRIBE and NOTIFY message types as identified for Instant Messaging.

14. The session initiated protocol (SIP) system of claim 13, further including SIP REGISTER message type.

15. The session initiated protocol (SIP) system of claim 14 wherein the registration information is encrypted.

16. The session initiated protocol (SIP) system of claim 1 wherein command messages are authenticated.

17. The session initiated protocol (SIP) system of claim 16 wherein the authentication is by means of a check for repeated messages by comparing one of the Timestamp: and Cseq: fields of the message against previously stored messages.

18. The session initiated protocol (SIP) system of claim 16 wherein the authentication is by means of a comparison of the Timestamp field to the current system time.

19. The session initiated protocol (SIP) system of claim 1 wherein command messages are encrypted.

20. The session initiated protocol (SIP) system of claim 19 wherein command messages are encrypted with a public key.

21. The session initiated protocol (SIP) system of claim 19 wherein command messages are encrypted with one of a private key and password.

22. The session initiated protocol (SIP) system of claim 1 wherein command messages have the portion of their URL to the left of the @ encrypted.

23. A method for communicating between a client and at least one networked appliance, comprising the steps of:
forming at least one SIP command message wherein the SIP command message includes a universal resource locator (URL) without location information otherwise specified in the SIP message and a generalized payload body with at least one of control and query instructions specific to appliances;
sending the SIP command messages to a user agent server (UAS) processor associated with said appliance over a communications network by means of a user agent client (UAC) processor;
receiving at the UAS processor the command message intended for said appliance;
translating the received SIP command into instructions recognized by the appliance; and
sending the instructions to the appliance.

24. A method for communicating between a client and at least one networked appliance as set forth in claim 23, wherein the command message is a query and further comprising the steps of:
receiving at the UAS processor status information from the appliance in response to a command message query;
translating the status information into a SIP protocol status message;
transmitting the protocol status message over the communications network to said UAC processor; and
displaying the status at the UAC processor.

25. A method for communicating between a client and at least one networked appliance as set forth in claim 23, wherein the sending and transmitting steps occur via communication through at least one proxy server.
